(19) United States
(12) Patent Application Publication
(10) Pub. No.: US 2017/0026487 A1
(43) Pub. Date: Jan. 26, 2017

(54) SYSTEMS AND METHODS FOR DYNAMIC TRANSPORT PROTOCOL LAYER MANAGEMENT FOR AVIONICS SYSTEM

(71) Applicants: Louis T. TOTH, Morristown, NJ (US); Michael L. OLIVE, Morris Plains, NJ (US); Jian SUN, Morristown, NJ (US); Likun ZOU, Morristown, NJ (US); Honeywell International Inc., Morris Plains, NJ (US)

(72) Inventors: Louis T. Toth, Baltimore, MD (US); Michael L. Olive, Cockeysville, MD (US); Jian Sun, Beijing (CN); Likun Zou, Beijing (CN)

(21) Appl. No.: 15/301,761

(22) PCT Filed: Apr. 10, 2014
(86) PCT No.: PCT/CN2014/075054

§ 371 Date: Oct. 4, 2016

(51) Int. Cl. H04L 29/08; H04L 29/06; H04L 12/859; H04L 12/813

(52) U.S. Cl. CPC H04L 67/303; H04L 47/20; H04L 69/165; H04L 47/2475; H04L 67/125; G08G 5/0013

(57) ABSTRACT

Systems and methods for dynamic transport protocol layer management for avionics system are provided. In one embodiment, a method for providing dynamic transport protocol layer management for avionics applications comprises: selecting an air-ground communication IP datalink based at least in part on criteria defined by one or more profile and policy definitions; selecting a transport layer protocol based on the air-ground communication IP datalink selected and further based on criteria defined by the one or more profile and policy definitions; and instantiating a port entity to transport air-ground communications between a first on-board application and the air-ground communication IP datalink through a Socket API, based on the selected transport layer protocol.

### BACKGROUND

Modern aircraft are equipped with communications equipment that support multiple datalink options for establishing communications between on-board applications and ground based applications. Examples of commonly available datalinks include, but are not limited to, satellite communication (SATCOM) datalinks, VHF radio communication datalinks, Wi-Fi datalinks and cellular communication datalinks. Typically, a communications manager on-board an aircraft maintains quality and availability information for various datalinks and has the ability to automatically select a datalink for establishing air-ground communication based on predefined preference profiles. The concept of IP-based policy-based communications management and datalink management is based on the AEEC specification 839 on Manager of Air/Ground Interface Communications (MAGIC). A growing volume of air-ground communications is formatted based on the Internet Protocol Suite (IPS) of standards. In fact, there are plans in the airline industry for migrating all air-ground communications that carry Air Traffic Management (ATM) services from existing ATN communications based on ISO/OSI standards to ATN communications based on IPS standards. One reason for this planned transition is that IPS permits use of new broadband Internet Protocol (IP)-based air-ground datalinks and facilitates standardized straight-forward connectivity with IP-based ground networks. That is, aircraft applications will communicate with ground-based applications using broadband air-ground datalinks implemented with standard IPS protocols.

The International Civil Aviation Organization has issued standard ICAO 9896, which specifies that the IPS standard communications stack should be used to implement IP air-ground datalinks. In ICAO 9896, two types of transport protocols are specified: the Transport Control Protocol (TCP) and User Datagram Protocol (UDP). TCP provides a very reliable transport protocol, but its performance is susceptible to latency affects such as those inherent in certain datalinks (for example, SATCOM datalinks). UDP is a connectionless transport and does not suffer performance problems due to latency, but at the cost of reliability. For example, UDP does not provide for reliability capabilities such as acknowledgments, timeouts, retransmissions, packet-ordering and flow control. The decision as to which of these two transport protocols is used by an application is made during the software development stage.

One problem with using IPS for air-ground communications is that characteristics of the datalink selected by the on-board communication manager can adversely affect the performance of TCP and UDP communications in different ways. For example, the on-board communications manager may selects a SATCOM datalink when, for example, other datalinks are either unavailable or are experiencing temporary quality issues. SATCOM, while reliable, is known to have latency issues. Therefore an application utilizing TCP may have its air-ground communications spuriously interrupted by latency caused time-out events. This can lead to driving up the costs of completing that communication due to the resulting necessity of package re-transmissions.

For the reasons stated above and for other reasons stated below which will become apparent to those skilled in the art upon reading and understanding the specification, there is a need in the art for improved systems and methods for dynamic transport protocol layer management for avionics systems.

### SUMMARY

The Embodiments of the present invention provide methods and systems for dynamic transport protocol layer management for avionics systems and will be understood by reading and studying the following specification.

Systems and methods for dynamic transport protocol layer management for avionics system are provided. In one embodiment, a method for providing dynamic transport protocol layer management for avionics applications comprises: selecting an air-ground communication IP datalink based at least in part on criteria defined by one or more profile and policy definitions; selecting a transport layer protocol based on the air-ground communication IP datalink selected and further based on criteria defined by the one or more profile and policy definitions; instantiating a port entity based on the selected transport layer protocol; and transporting air-ground communication messages between a first on-board application and a radio associated with the selected air-ground communication IP datalink via the port entity using a Socket API.

### DRAWINGS

Embodiments of the present invention can be more easily understood and further advantages and uses thereof more readily apparent, when considered in view of the description of the preferred embodiments and the following figures in which:

FIG. 1 is a block diagram illustrating a system of one embodiment of the present disclosure;

FIG. 2 is a block diagram illustrating a system of one embodiment of the present disclosure;

FIG. 3 is a block diagram illustrating a system of one embodiment of the present disclosure;

FIG. 4 is a flow chart illustrating a process of one embodiment of the present disclosure.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present disclosure address the aforementioned problems with systems and methods that dynamically select between using TCP and UDP for IPS communications over datalinks. The transport layer protocol is selected by an on-board IP-Based Communications Manager (ICM) and parameters may be configured to adapt the transport layer to meet the quality of service (QoS) needs of the aircraft application utilizing the datalink and the QoS capability of the air-ground datalink selected to provide the air-ground communications services for the aircraft application.

As mentioned above, whereas TCP is connection-oriented, UDP is connectionless. UDP is a lighter weight protocol than TCP because it does not have the reliability mechanisms found in TCP. UDP however may still be a better alternative than TCP for certain applications, datalinks and QoS needs where an application layer above UDP can take on the responsibility of reliable communications, packet-ordering and flow control to the extent needed. The application layer over UDP can have the flexibility of being configurable to adapt to the inherent performance of datalinks and still provide the QoS needed by the aircraft applications. For example, factors such as bandwidth and coverage may make SATCOM the preferred or only datalink choice for air-ground communications when an aircraft is in a particular airspace. But, TCP performance degradations due to latency may prevent TCP over SATCOM from meeting the QoS needs of the application. As described below, UDP can be selected and configured so that in these cases an adequate level of transport reliability is provided. If TCP is still the better choice for another application, datalink and QoS, then TCP may be selected and configured appropriately for the situation. As described herein, embodiments of the present disclosure describe embodiments for dynamically selecting between TCP and UDP, and configuring the selected transport based on the QoS needs of the application and the QoS capability of the selected air-ground datalink.

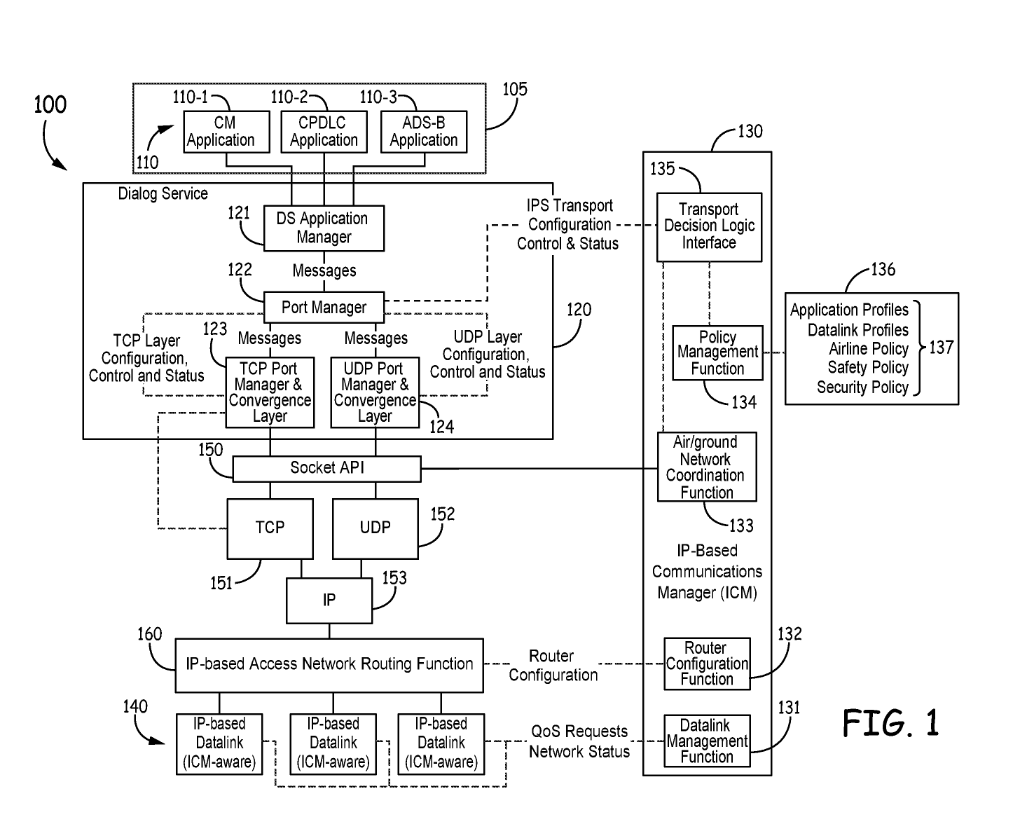

FIG. 1 is a block diagram illustrating one embodiment of an on-board aircraft communication system 100 of one embodiment of the present disclosure. System 100 is drawn to meeting the air-ground communications needs of legacy air traffic management (ATM) applications (shown at 110-1, 110-2 and 110-3 and referred to collectively herein as applications 110). In the embodiment shown in FIG. 1, applications 110 are executed by an avionics computer system 105 which includes at least one processor for executing the applications 110. As the term is used throughout this disclosure, “air-ground communication” refers to communications between an application executed on-board an aircraft and corresponding application at a ground station. As such, the term is intended to encompass bi-directional communications. In the embodiment shown in FIG. 1, ATM applications 110 include a Context Management (CM) application 110-1, a Controller Pilot Datalink Control (CPDLC) application 110-2 and an Automatic Dependence Surveillance-Broadcast (ADS-B) application 110-3. The mention of these air traffic management applications are not intended to be limiting, but are provided as illustrative examples. In other embodiments, ATM applications 110 may include a set comprising different applications, or a greater or fewer number of applications.

Each of the ATM applications 110 are communicatively coupled to a dialog service (DS) module 120, which includes a DS Application Manager 121, an Port Manager 122, a TCP Port Manager & Convergence Layer 123, and a UDP Power Manger & Convergence Layer 124.

System 100 further comprises and IP-Based Communication Manager (ICM) 130 which is communicatively coupled to the DS module 120. ICM 130 includes a datalink management function 131, a router configuration function 132, an air-ground network coordination function 133, a policy management function 134 (which is coupled to a memory 136 that stores one or more profile and policy definitions 137) and a Transport Decision Logic and Interface 135 (which in FIG. 1 communicates with the Port Manager 122 of the DS module 120).

IP Datalinks 140 represent the wireless radio communication hardware options available to system 100 for establishing air-ground communications. IP Datalinks 140 may include one or more of SATCOM, UHV and VHF radio, Wi-Fi and cellular communication datalinks. As indicated in FIG. 1, one or more of IP Datalinks 140 are “ICM-aware” meaning that they comprise an interface for communicating with the ICM 130. More specifically, IP Datalinks 140 each communicate QoS and datalink network status information specific to their particular datalink with the Datalink Management Function 131. Datalink Management Function 131 in turn can determine the status (e.g., an availability and/or quality) for each of the IP Datalinks 140 and communicate with them to make requests for bandwidth allocation to support air-ground communications. That is, via the Datalink Management Function 131, ICM 130 manages the IP Datalinks 140 to obtain status and to request QoS based on current application needs and datalink availability and conditions.

The ICM 130 is the decision point for IPS transport selection and configuration as well as IP Datalink 140 selection. ICM 130 makes these decisions based on an application profile (as provided by the profile and policy definitions 137) and current QoS needs of the application requesting the air-ground communication, a datalink profile (as provided by the profile and policy definitions 137) and current availability and QoS capability of datalinks 140, and one or more other policies (as provided by the profile and policy definitions 137). The one or more policies provided by the profile and policy definitions 137 may include a policy defining an airline's preferences on datalink usage, as well as a security policy and a flight safety policy. The determination of which of the profile and policy definitions 137 are appropriate for making a particular datalink and transport protocol decision is handled by policy management function 134.

Transport Decision Logic and Interface 135 controls the Port Manager 122 to direct communications between the applications 110 and a selected port, either TCP or UDP ports. In addition to IPS transport protocol selection, Transport Decision Logic and Interface 135 further interfaces with the Port Manager 122 for status and configuration purposes.

The DS module 120 is the application layer function that supports IPS transport layer protocol selection and configuration. The Port Manager 122 controls the selection between TCP and UDP and configures the TCP and UDP protocol parameters on a port by port basis. This function manages the TCP and UDP Port Manager & Convergence Layers (123 and 124, respectively). As shown in FIG. 1, the TCP and UDP Port Manager & Convergence Layers 123, 124 are coupled to and operate over a standard Socket API 150.

In operation, DS Application Manager 121 receives a communication message from one of the applications 110 and sends that message to the Port Manager 122. The Port Manager sends that message to either to the TCP Port Manager & Convergence Layer 123 or the UDP Port Manager & Convergence Layer 124. Each of the layers 123, 124 are coupled to and receive configuration, control and status information from the Port Manager 122. Therefore, depending on the transport layer protocol selected by ICM 130, either TCP Port Manager & Convergence Layer 123 or UDP Port Manager & Convergence Layer 124 will be configured to instantiate a port entity and handle communications for the application using standard function calls to Socket API 150. Socket API 150 will in turn utilize either the TCP (shown at 151) or UDP (shown at 152) underlying transport protocol layers.

A port in the context of this disclosure represents a port entity and a port number. Each port entity is instantiated to provide transport services with a transport context defined for a particular application, datalink and QoS. A transport context is defined by the selected protocol, TCP or UDP, and settings of parameters in the selected protocol. Port entity instantiation is provided by the respective TCP and UDP Port Manager & Convergence layers 123 and 124.

In one embodiment, TCP and UDP port entities use the standard Socket API 150 and TCP/UDP/IP protocols. A TCP port entity may use the standard Socket API 150 and kernel network interface to configure TCP for a particular application 110, datalink 140 and the needed QoS. In one embodiment, it uses the TCP services provided through the Socket API 150. In some embodiments, TCP Port Manager & Convergence layer 123 communicates directly with the TCP-layer 151 to configure timing and other reliability parameters. A UDP port entity may provide additional functionality to provide reliability, packet-ordering and flow control that use of the UDP layer 152 does not inherently provide. In one embodiment, a common UDP port entity class provides the configurable functionality. A port entity instantiation or object is configured for the particular application, datalink and QoS. It uses the UDP services provided through the Socket API 150. Standardized IP addressing and port numbering are also configured through the instantiated ports.

Since the transport layer handles the end-to-end delivery of information, selection and configuration of the IPS transport in the avionics requires coordination with the ground end system, such as an ATC Center or airline operations center, or with the air-ground service provider ground system, which provides the air-ground services for air traffic control and airline operations centers. In one embodiment, the air-ground network coordination function 133 also interfaces with Socket API 150 to provide coordination between the aircraft and the ground applications as to which transport layer protocol has been selected prior to initiating communication of application messages over the selected datalink 140. That is, the air-ground network coordination function 133 in the ICM 130 coordinates with a peer function in a ground system about IPS transport selection and configuration. Any currently available IP-based air-ground data and network can be used for this coordination.

After the selected transport layer protocol is applied and the message is formatted for transport over an IP network at block 153 and forwarded to IP-based Access Network Routing Function 160. IP-based Access Network Routing Function 160 is further coupled to each of the IP datalinks 140 via a respective router port. Routing tables and other routing configuration parameters are controlled by the router configuration function 132 of the ICM 130. Based on the datalink 140 selected by datalink management function 131 for carrying out an air-ground communication, router configuration function 132 configures IP-based Access Network Routing Function 160 to route messages to and from the appropriate router port associated with the datalink 140 selected to facilitate the air-ground communication for the application 110.

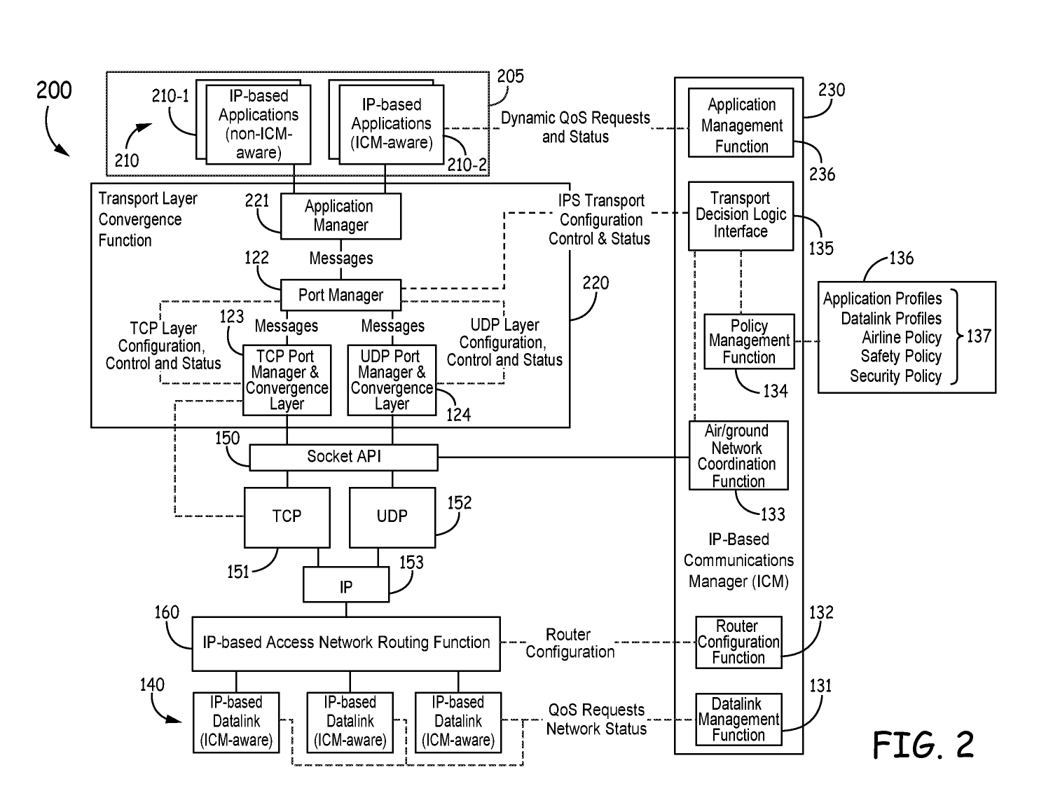

FIG. 2 is a block diagram illustrating one embodiment of an on-board aircraft communication system 200 of another embodiment of the present disclosure. System 200 is substantially similar to system 100 so that similarly numbered elements in FIG. 2 will provide the same functionality as described with respect to FIG. 1, except as noted below. In this embodiment, system 200 is drawn to providing air-ground communications for IP-based applications 210 that communicate Aeronautical Operational Control (AOC) and Aeronautical Administrative Communication (AAC) information over IP-based datalinks 140. In the embodiment shown in FIG. 2, applications 210 are executed by an avionics computer system 205 which includes at least one processor for executing the applications 210. Some of applications 210, such as shown at 210-2, are ICM-aware in that they can dynamically request QoS changes. Non-ICM-aware applications, shown at 210-1, are statically profiled only and cannot make dynamic requests.

System 200 comprises an ICM 230 which includes the same elements and functionalities described with respect to ICM 130, but further comprises an Application Management Function 236. Application Management Function 236 provides ICM 230 with an interface with the ICM-aware applications 210-2 through which these applications can dynamically request from ICM 230 changes in QoS needs (such as data throughput, for example) and ICM 230 can share with the applications 210-2 information such as the availability status of each of the datalinks 140. Through such an exchange of information, an application may, for example, determine whether it can make adjustments in the rate at which it is communicating data with a ground application.

System 200 also comprises a Transport Layer Convergence Function 220 which includes the same elements and functionalities described with respect to DS module 120, except that DS application manger 121 is replaced by an Application Manager 221. Application manager 221 communicates with IP-based applications 210 and facilitates the transport of IP message traffic between the IP-based applications 210 and the TCP Port Manager & Convergence Layer 123 and the UDP Power Manger & Convergence Layer 124.

In the same manner described in FIG. 1, the Port Manager 122 controls the selection between TCP and UDP and configures the TCP and UDP protocol parameters on a port by port basis. This function manages the TCP and UDP Port Manager & Convergence Layers (123 and 124, respectively).

The TCP and UDP Port Manager & Convergence Layers 123, 124 are coupled to and operate over a standard Socket API 150. In operation, Application Manager 121 receives a communication message from one of the applications 210 and sends that message to the Port Manager 122. The Port Manager sends that message to either the TCP Port Manager & Convergence Layer 123 or the UDP Port Manager & Convergence Layer 124. Each of the layers 123, 124 are coupled to and receive configuration and control information from the Port Manager 122 and send status information to the Port Manager 122. Depending on the transport layer protocol selected by ICM 130, either TCP Port Manager & Convergence Layer 123 or UDP Port Manager & Convergence Layer 124 will be configured to instantiate a port entity and handle communications for the application using standard function calls to Socket API 150. Socket API 150 will in turn utilize either the TCP (shown at 151) or UDP (shown at 152) underlying transport protocol layers.

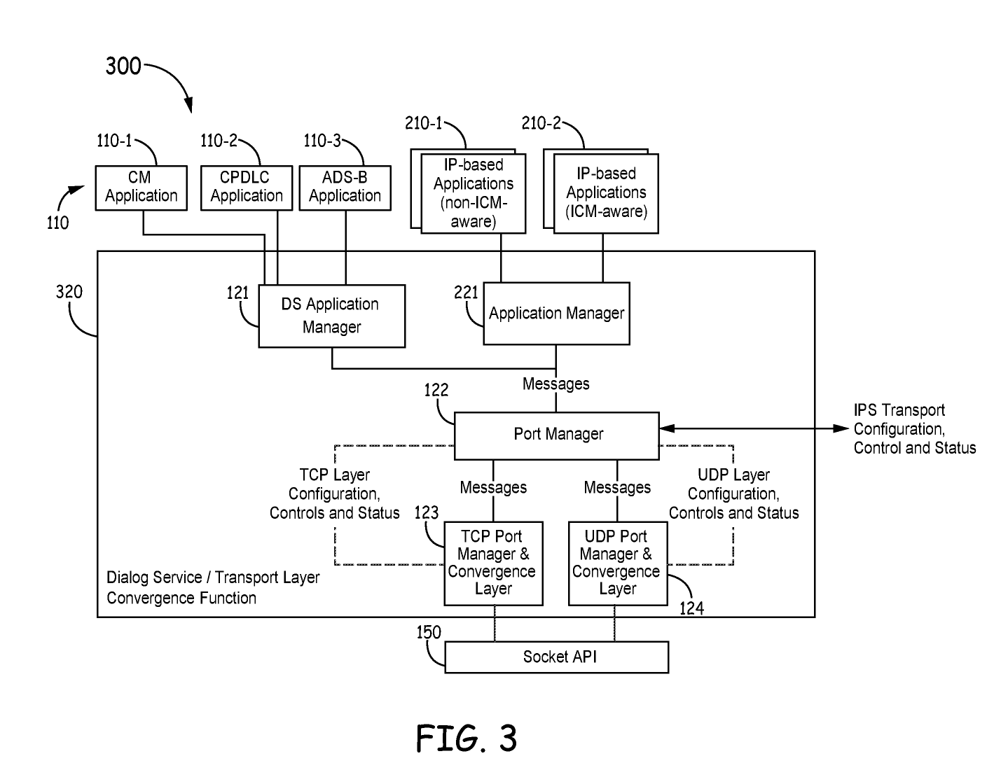

It should be appreciated that embodiments comprising a combination of system 100 and system 200 are also contemplated as within the scope of the present disclosure. For example, in one embodiment, ICM (such as ICM 230) may be coupled to a dialog service module that handles communications with ATM applications such as illustrated with system 100, and also coupled to a transport layer convergence function that handles communications with IP-based applications such as illustrated with system 200. In still other embodiments, the functions provided by dialog service module 120 and transport layer convergence function 220 are both integrated into a single DS/transport layer convergence function such as shown generally at 320 in FIG. 3.

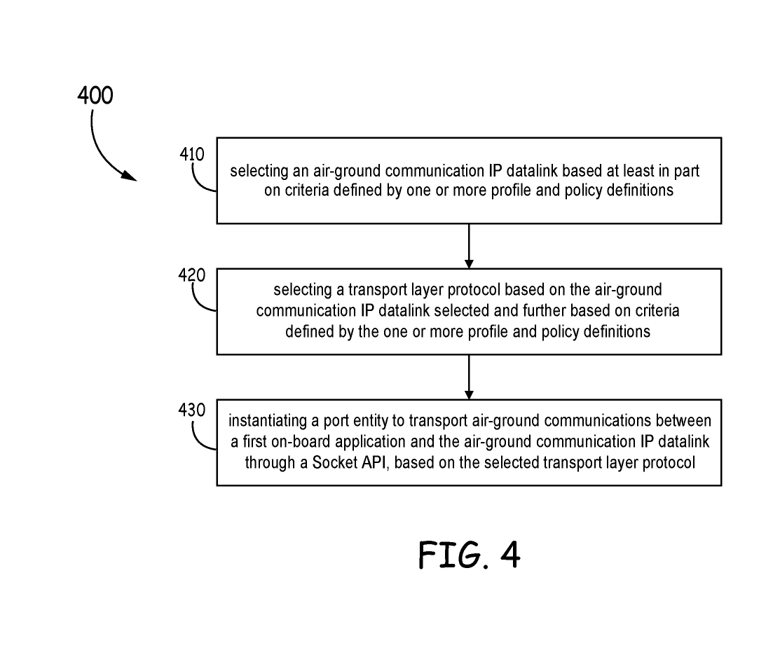

FIG. 4 is a flow chart illustrating a method 400 of one embodiment of the present disclosure for providing dynamic transport protocol layer management for avionics applications. The method begins at 410 with selecting an air-ground communication IP datalink based at least in part on criteria defined by one or more profile and policy definitions. The air-ground communication IP Datalinks may comprise a datalink such as, but not limited to a SATCOM, VHF radio, a Wi-Fi or cellular communication datalink. Selection of the air-ground communication IP datalink may further be based on datalink availability, cost, data bandwidth, latency, timeliness, as well as other QoS factors.

The method proceeds to 420 with selecting a transport layer protocol based on the air-ground communication IP datalink selected and further based on criteria defined by the one or more profile and policy definitions. In one embodiment, block 420 comprises selecting between the Transport Control Protocol (TCP) and the User Datagram Protocol (UDP). This selection may be based at least in part on the QoS needs of an application requesting the air-ground communication, and the QoS capability of the selected air-ground datalink. In other embodiment, the selection of transport layer protocol is based at least in part on criteria defined one or more profile and policy definitions. The method proceeds to 430 with instantiating a port entity to transport air-ground communications between a first on-board application and the air-ground communication IP datalink through a Socket API, based on the selected transport layer protocol. As mentioned above, each port entity is instantiated to provide transport services with a transport context defined for a particular application, datalink and QoS. A transport context is defined by the selected protocol, TCP or UDP, and settings of parameters in the selected protocol. Port entity instantiation is provided by the respective TCP and UDP convergence layers. Air-ground communication messages can then be communicated between the first on-board application and a radio associated with the selected air-ground communication IP datalink. In some embodiments, the first on-board application may comprise one of a plurality of non-IP based air traffic management (ATM) applications such as described above. In other embodiments, the first on-board application may comprise one of a plurality of IP based applications such as described above. In such an embodiment, the IP based application may be characterized as being either ICM-aware or non-ICM aware. Where the IP based application is ICM-aware, one or both of the selections at blocks 410 and 420 may be at least in part based on preferences communicated by the application. Further, some embodiments of the present disclosure comprise multiple instances of method 400 being performed concurrently.

### Example Embodiments

Example 1 includes a method for providing dynamic transport protocol layer management for avionics applications, the method comprising: selecting an air-ground communication IP datalink based at least in part on criteria defined by one or more profile and policy definitions; selecting a transport layer protocol based on the air-ground communication IP datalink selected and further based on criteria defined by the one or more profile and policy definitions; and instantiating a port entity to transport air-ground communications between a first on-board application and the air-ground communication IP datalink through a Socket API, based on the selected transport layer protocol.

Example 2 includes the method of example 1, wherein the air-ground communication IP datalink comprises one of a satellite communications (SATCOM) datalink, a VHF radio datalink, a Wi-Fi datalink, a cellular communication datalink or a broadband IP-based air-ground datalink.

Example 3 includes the method of any of examples 1-2, wherein selecting the air-ground communication IP datalink is further based on at least one of datalink availability, cost, data bandwidth, latency, timeliness, and QoS factors.

Example 4 includes the method of any of examples 1-3, wherein selecting the transport layer protocol comprises selecting between the Transport Control Protocol (TCP) and the User Datagram Protocol (UDP).

Example 5 includes the method of any of examples 1-4, wherein selecting the transport layer protocol is based at least in part on one or both of the QoS needs of the first application, and the QoS capability of the selected air-ground communication IP datalink.

Example 6 includes the method of any of examples 1-5, wherein the first on-board application comprises one of a plurality of non-IP based air traffic management (ATM) applications.

Example 7 includes the method of any of examples 1-6, wherein the first on-board application comprises one of a plurality of IP-based applications.

Example 8 includes the method of any of examples 1-7, wherein one or both of selecting an air-ground communication IP datalink and selecting a transport layer protocol are based at least in part on preferences communicated by the first on-board application.

Example 9 includes a system for providing dynamic transport protocol layer management for avionics applications, the system comprising: a plurality of Internet Protocol (IP) based datalinks; an avionics computer system comprising at least one processor, wherein the avionics computer is on-board an aircraft; a first module on-board the aircraft and in communication with one or more avionics applications executing on the avionics computer system and further in communication with a Socket Application Programming Interface (API), the first module including a first transport layer protocol manager and convergence layer and a second transport layer protocol manager and convergence layer; a communications manager on board the aircraft and coupled to the first module; wherein based on a transport decision communicated by the communications manager, the first module configures one of the first transport layer protocol manager and convergence layer or the second transport layer protocol manager and convergence layer to instantiate a port entity to transport air-ground communications between a first application of the one or more avionics applications and a first IP based datalink of the plurality of IP based datalinks through the Socket API.

Example 10 includes the system of example 9, wherein the first transport layer protocol manager and convergence layer comprises a Transport Control Protocol (TCP) port manager and convergence layer; and the second transport layer protocol manager and convergence layer comprises a User Datagram Protocol (UDP) port manager and convergence layer.

Example 11 includes the system of any of examples 9-10, wherein the first application comprises a non-IP based air traffic management (ATM) application.

Example 12 includes the system of any of examples 9-11, wherein the first application comprises an IP-based application.

Example 13 includes the system of any of example 9-12, wherein the transport decision communicated by the communications manager is based at least in part on preferences communicated by the first application to the communications manager

Example 14 includes the system of any of examples 9-13, wherein the communications manager comprises a datalink management function that selects the first IP based datalink for transporting the air-ground communications from the plurality of IP based datalinks.

Example 15 includes the system of example 14, wherein the first IP based datalink comprises one of a satellite communications (SATCOM) datalink, a VHF radio datalink, a Wi-Fi datalink, a cellular communication datalink or a broadband IP-based air-ground datalink.

Example 16 includes the system of example 14, wherein the communication manger is further coupled to an IP-based Access Network Routing Function on-board the aircraft, wherein the communication manager send router configuration to the IP-based Access Network Routing Function to route the air-ground communications messages associated with the first application to the first IP based datalink.

Example 17 includes the system of any of examples 14, wherein the datalink management function selects the first IP based datalink based on one or more of datalink availability, cost, data bandwidth, latency, timeliness, and QoS factors.

Example 18 includes the system of any of examples 9-17, wherein selecting the transport layer protocol based at least in part on one or both of the QoS needs of the first application, and the QoS capability of the selected air-ground communication IP datalink.

Example 19 includes the system of any of examples 9-18, the communication manager further comprising an air-ground network coordination function that communicates the transport decision to at least one ground based application.

Example 20 includes the system of any of examples 9-19, the communication manager further comprising a policy management function coupled to a memory that stores one or more profile and policy definitions; wherein the communication manager generates the transport decision based at least in part on the one or more profile and policy definitions.

In various alternative embodiments, any of the systems or methods described throughout this disclosure may be implemented on one or more on-board avionics computer systems comprising a processor executing code to realize the modules, functions, managers, software layers and interfaces and other elements described with respect to FIGS. 1-4, said code stored on an on-board non-transient data storage device. Therefore other embodiments of the present disclosure include program instructions resident on computer readable media which when implemented by such on-board avionics computer systems, enable them to implement the embodiments described herein. As used herein, the term “computer readable media” refers to tangible memory storage devices having non-transient physical forms. Such non-transient physical forms may include computer memory devices, such as but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device having a physical, tangible form. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method for providing dynamic transport protocol layer management for avionics applications, the method comprising:
selecting an air-ground communication IP datalink based at least in part on criteria defined by one or more profile and policy definitions;
selecting a transport layer protocol based on the air-ground communication IP datalink selected and further based on criteria defined by the one or more profile and policy definitions; and
instantiating a port entity to transport air-ground communications between a first on-board application and the air-ground communication IP datalink through a Socket API, based on the selected transport layer protocol.

2. The method of claim 1, wherein the air-ground communication IP datalink comprises one of a satellite communications (SATCOM) datalink, a VHF radio datalink, a Wi-Fi datalink, a cellular communication datalink or a broadband IP-based air-ground datalink.

3. The method of claim 1, wherein selecting the air-ground communication IP datalink is further based on at least one of datalink availability, cost, data bandwidth, latency, timeliness, and QoS factors.

4. The method of claim 1, wherein selecting the transport layer protocol comprises selecting between the Transport Control Protocol (TCP) and the User Datagram Protocol (UDP).

5. The method of claim 1, wherein selecting the transport layer protocol is based at least in part on one or both of the QoS needs of the first application, and the QoS capability of the selected air-ground communication IP datalink.

6. The method of claim 1, wherein the first on-board application comprises one of a plurality of non-IP based air traffic management (ATM) applications.

7. The method of claim 1, wherein the first on-board application comprises one of a plurality of IP-based applications.

8. The method of claim 1, wherein one or both of selecting an air-ground communication IP datalink and selecting a transport layer protocol are based at least in part on preferences communicated by the first on-board application.

9. A system for providing dynamic transport protocol layer management for avionics applications, the system comprising:
a plurality of Internet Protocol (IP) based datalinks;
an avionics computer system comprising at least one processor, wherein the avionics computer is on-board an aircraft;
a first module on-board the aircraft and in communication with one or more avionics applications executing on the avionics computer system and further in communication with a Socket Application Programming Interface (API), the first module including a first transport layer protocol manager and convergence layer and a second transport layer protocol manager and convergence layer; and
a communications manager on board the aircraft and coupled to the first module;
wherein based on a transport decision communicated by the communications manager, the first module configures one of the first transport layer protocol manager and convergence layer or the second transport layer protocol manager and convergence layer to instantiate a port entity to transport air-ground communications between a first application of the one or more avionics applications and a first IP based datalink of the plurality of IP based datalinks through the Socket API.

10. The system of claim 9, wherein the first transport layer protocol manager and convergence layer comprises a Transport Control Protocol (TCP) port manager and convergence layer; and
the second transport layer protocol manager and convergence layer comprises a User Datagram Protocol (UDP) port manager and convergence layer.

11. The system of claim 9, wherein the first application comprises a non-IP based air traffic management (ATM) application.

12. The system of claim 9, wherein the first application comprises an IP-based application.

13. The system of claim 9, wherein the transport decision communicated by the communications manager is based at least in part on preferences communicated by the first application to the communications manager

14. The system of claim 9, wherein the communications manager comprises a datalink management function that selects the first IP based datalink for transporting the air-ground communications from the plurality of IP based datalinks.

15. The system of claim 14, wherein the first IP based datalink comprises one of a satellite communications (SATCOM) datalink, a VHF radio datalink, a Wi-Fi datalink, a cellular communication datalink or a broadband IP-based air-ground datalink.

16. The system of claim 14, wherein the communication manger is further coupled to an IP-based Access Network Routing Function on-board the aircraft, wherein the communication manager send router configuration to the IP-based Access Network Routing Function to route the air-ground communications messages associated with the first application to the first IP based datalink.

17. The system of claim 14, wherein the datalink management function selects the first IP based datalink based on one or more of datalink availability, cost, data bandwidth, latency, timeliness, and QoS factors.

18. The system of claim 9, wherein selecting the transport layer protocol based at least in part on one or both of the QoS needs of the first application, and the QoS capability of the selected air-ground communication IP datalink.

19. The system of claim 9, the communication manager further comprising an air-ground network coordination function that communicates the transport decision to at least one ground based application.

20. The system of claim 9, the communication manager further comprising a policy management function coupled to a memory that stores one or more profile and policy definitions;
wherein the communication manager generates the transport decision based at least in part on the one or more profile and policy definitions.
